(19) United States
(12) Patent Application Publication
(10) Pub. No.: US 2012/0204352 A1
(43) Pub. Date: Aug. 16, 2012

(54) Stall knife

(76) Inventor: Sandy James Hanson, Sturgis, SD (US)

(21) Appl. No.: 12/931,832

(22) Filed: Feb. 11, 2011

(51) Int. Cl. A01D 11/06

(52) U.S. Cl. 7/115

(57) ABSTRACT

A stall knife is disclosed which may be affixed to a stall fork and used as necessary to cut twine, packaging, or similar materials.

### BACKGROUND OF THE INVENTION

1. Field of the Invention

The present invention relates generally to stall or pitch forks and more specifically to a stall knife which may be affixed to a stall fork.

2. Background Information

For many years people have used pitch forks for a variety of uses. In recent years such pitch forks are more commonly called stall forks. A stall fork is traditionally used to scoop manure out of a horse stall, but it has many other uses. Stall forks are often used to pitch hay or feed supplements into a feed bunk. In addition to agricultural uses, stall forks are often used in other areas such as construction. In many instances, the material which is to be manipulated using a stall fork comes packaged in a paper or plastic bag or is secured by twine or string. When such material comes in a package, the user must open the package before the material may be used. Most often a knife of some type is used to open the packaging material or string.

That is, a knife is used to open the packaging and a stall fork is used to distribute the material. This involves a two item, two part operation. The knife must be secured and then used. Then the stall fork is used to manipulate the material. The user must find the knife, use the knife, secure the knife, pick up the stall fork and use the stall fork.

The stall knife of the instant invention solves the above related problems with using a knife and a stall fork. The instant invention includes a knife which may be removably affixed to a stall fork such that they may be used in conjunction with each other. The ideal stall knife should be able to be removably affixed to a stall fork such that they may be used together. The ideal invention should also provide for a method and position of attachment of the knife with the stall fork such that the knife does not interfere with the operation of the stall fork. The ideal invention should also be simple, reliable, inexpensive, and easy to operate and maintain.

### SUMMARY OF THE INVENTION

The stall knife of the instant invention is made to be used with a conventional stall fork. Although there are a variety of stall forks available, they generally have a handle portion and a fork portion. When the bottom of the fork portion is horizontal, the handle portion is at an angle to the bottom of the fork portion which is somewhat greater than 90 degrees. The fork portion has tines and the tines are ordinarily bent such that when the lower portion of the fork is horizontal, the tines nearest the handle portion are aligned with the handle portion. The stall fork is not considered a part of the invention.

The stall knife includes a knife portion and a fastening portion. The fastening portion is capable of removably affixing the stall knife to the tines of the stall fork aligned with the handle portion of the stall fork. The knife portion of the stall knife projects rearward from the tines of the stall fork and may be used to cut string or packaging material as necessary without the need to put the stall fork down and use a separate knife. The stall knife is positioned such that it does not interfere with the normal use of the stall fork.

Although the stall knife is described as being affixed to an existing stall fork, it could easily be manufactured as a part of a stall fork.

One of the major objects of the present invention to be removably affixed to a stall fork such that they may be used together.

Another objective of the present inventions is to provide for a method and position of attachment of the knife with the stall fork such that the knife does not interfere with the operation of the stall fork.

Another objective of the present invention is to provide a stall knife which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a side view of the stall knife of the instant invention;

FIG. 2 is an end view of the stall knife

FIG. 3 is a side view of the cap portion of the stall knife;

FIG. 4 is a side view of the blade portion of the stall knife; and

FIG. 5 is a side view of the stall knife affixed to a conventional stall fork.

### DESCRIPTION OF A PREFERRED EMBODIMENT

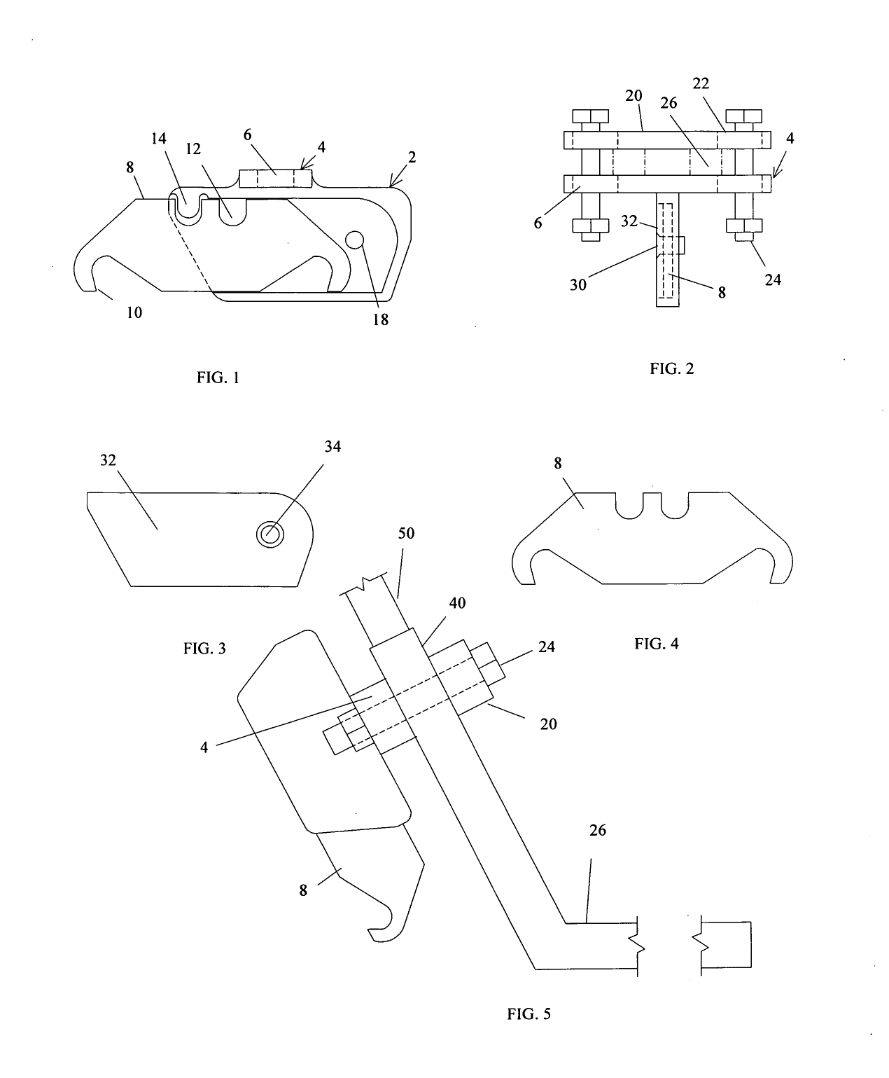

Referring to the drawings, FIG. 1 through 5 show different views of the stall knife of the instant invention. The invention is made to be used with a conventional stall fork and the stall fork is not considered part of the invention. A conventional stall fork has a fork portion and a handle portion. The lower fork portion of the stall fork is considered to protrude forward from the operator who is considered rearward of the stall fork.

Now referring to FIG. 1, a side view of the stall knife of the instant invention is shown. A case 2 is provided which is generally rectangular and having a hollow interior which is open on one side. A bracket 4 is affixed to one of the long sides of the case 2. There are bracket holes 6 through the bracket 4. A blade 8 fits within the hollow interior of said case 2 and protrudes out from the interior of said case 2 through the open side of said case 2. The blade 8 has a hook 10 which protrudes away from said bracket 4. Said blade 8 has a pair of slots 12 in its edge closest to said bracket 4. A pair of studs 14 protrude inward from the interior surface of said case 2 which is closest to said bracket 4. Each of said studs 14 is capable of engaging one of the slots 12 in said blade 8 and holding said blade 8 in position within said case 2.

Still referring to FIG. 1, said blade 8 is symmetrical with a hook 10 at either end. When one of said hooks 10 becomes dull, said blade 8 may be flipped over and the other of said hooks 10 exposed. A threaded hole 18 is provided through the interior of said case 2 opposite said studs 14. The hollow interior of said case 2 is sized such that it is slightly larger than said blade 8.

Referring now to FIG. 2 an end view of the stall knife of the instant invention is shown. As may be seen, said bracket 4 protrudes perpendicular from said case 2. A plate 20 is provided which is complementary to said bracket 4 and has plate holes 22 which may be aligned with said bracket holes 6. Bolts 24 may be used to affix the plate 20 to said bracket 4. When the invention is affixed to a stall fork, at least two tines 26 of the stall fork are captured between said plate 20 and said bracket 4 which removably affixes the stall knife to the stall fork. Said blade 8 is sandwiched between said case 2 and a cap 32 which fits within the hollow interior of said case 2 and is held in place by a case bolt 30 which screws into said threaded hole 18.

Referring now to FIG. 3, side view of the cap 32 of the stall knife is shown. Said cap 32 fits within the hollow interior of said case 2 and includes a countersunk cap hole 34 which may be aligned with said threaded hole 18.

Referring now to FIG. 4, a side view of the blade 8 of the stall knife is shown. Said blade 8 shown in this embodiment is made by Stanley Black and Decker of 1000 Stanley Drive, New Britain, Conn. 06053, and is called a roofing utility blade. Although the Stanley blade works well with this embodiment, it will be seen that a purpose built blade could easily be used.

Referring now to FIG. 5, side view of the stall knife affixed to a conventional stall fork is shown. A stall fork 40 represents any number of conventional stall forks currently available. The stall fork 40 has a tine 26 portion at the forward end and a handle 50 portion at the rearward end. When the forward portion of said tines 26 are in a generally horizontal in use position, the handle 50 and the rearward portion of said tines 26 are at an angle of more than 90 degrees to the forward portion of said tines 26. The stall knife of the instant invention is removably affixed to the rearward portion of said tines 26 by capturing at least two of said tines 26 between said plate 20 and said bracket 4 using said bolts 24 to secure the stall knife to the stall fork with the stall knife protruding rearward from said tines 26 and said blade 8 protruding downward. As may be seen, said blade 8 is, thus, position such that it does not interfere with the normal operation of the stall fork. However, said blade 8 may be used to cut packaging or string when necessary during the use of the stall fork.

All of the elements of the stall knife of the instant invention are made of aluminum in the preferred embodiment. However, any of the elements of the instant invention could be made from plastic, steel, or any other material having similar characteristics of strength, resilience, and chemical resistance.

While preferred embodiments of this invention have been shown and described above, it will be apparent to those skilled in the art that various modifications may be made in these embodiments without departing from the spirit of the present invention. That is, the device could be used for a wide variety of purposes either in combination or separately.

I claim:

1. A stall knife which may be used in conjunction with a stall fork, the stall fork having a handle at its rearward end and having tines affixed to the bottom of the handle and projecting forward from the handle, comprising:
(1) a bracket capable of being affixed to the tines of a stall fork; and
(2) a blade being affixed to the bracket such that the blade protrudes rearward from the tines of the stall fork such that the blade does not interfere with the normal operation of the stall fork and is sharpened.

2. The stall knife of claim 1 in which said blade is in the shape of a hook with the point of the hook projecting downward from said bracket and rearward.
